(19) United States
(12) Patent Application Publication
(10) Pub. No.: US 2018/0134412 A1
(43) Pub. Date: May 17, 2018

(54) INTELLIGENT DOCKING SYSTEM WITH AUTOMATED STOWAGE FOR UAVS

(71) Applicants: Chung Kiak POH, Penang (MY); Chung How POH, Penang (MY)

(72) Inventors: Chung Kiak POH, Penang (MY); Chung How POH, Penang (MY)

(21) Appl. No.: 15/566,603

(22) PCT Filed: Apr. 29, 2016
(86) PCT No.: PCT/MY2016/000023

§ 371 Date: Oct. 13, 2017

(30) Foreign Application Priority Data
Apr. 30, 2015 (MY) PI2015701399

(51) Int. Cl. B64F 1/12; B64C 39/02; H02S 20/30

(52) U.S. Cl. CPC B64F 1/12; B64C 39/024; H02S 20/30; B64C 2201/146; B64C 2201/187; B64C 2201/021; B64C 2201/084; B64C 2201/201; B64C 2201/141

(57) ABSTRACT

The present invention generally relates to a system and method of a docking system (1) for fixed wing unmanned aerial vehicle, or non-fixed wing unmanned aerial vehicle (2) such as rotorcraft, or combination thereof, comprising at least a docking and/or launching pad capable of being arranged in an array or staggered manner; said pad has a surface (6) for said vehicle docking and launching, said docking and launching surface (6) comprising moveable pads (31) which include electromagnets that can be energized to capture a docking vehicle (2); and another energy harvesting surface (4) has photovoltaic panel to harness solar energy to generate electricity or hydrogen fuel for a variety of on-board applications such as to charge said vehicle (2) and to power the docking system and providing a safe stowage and protected storage for the said vehicle (2).

### 1. TECHNICAL FIELD OF THE INVENTION

The present invention generally relates to a system and method of a docking system for unmanned aerial vehicles (UAVs) and in particular it relates to an autonomous docking and relaunching system that caters for vertical take-off and landing (VTOL) in a safe and secure manner.

### 2. BACKGROUND OF THE INVENTION

Fixed-wing UAVs triumph over non-fixed/rotary-wing UAVs in terms of flight endurance, which is a highly valuable attribute for many applications such as surveillance. However, a key disadvantage of fixed-wing aircraft is that they generally require a runway for taking off and landing with an airspeed of approximately 30 kmh⁻¹ and above depending on the wing loading. The kinetic energy (KE) associated with the forward velocity of the aircraft has to be dissipated in a gradual manner prior to the touch-down phase to prevent structural damage to the airframe.

Efforts have been made to develop airplanes that can perform vertical take-off and landing (VTOL) and thus eliminating the need for runway and the dissipation of KE upon touched down. Modern aerobatic model including fixed wing UAVs having the abilities to perform an array of impressive post-stall manoeuvers known as “3D aerobatics” such as hovering (including VTOL), waterfall, flatspin, blender, tailslide and their derivatives. A potentially useful manoeuver that can be used for docking and launching of these airplanes is the “Harrier” (i.e. to fly in trim with nose angle of 45° or greater). During the “Harrier” manoeuver, the altitude of the aircraft can be altered depending on the throttle level.

However, present day solutions often involve significant increase in mechanical complexity of the aircraft which in turn deteriorate the reliability and safe operation of the aircraft. This invention recognizes that an airframe that keeps complex mechanical component count to the minimum is critical to mission success.

Prior art systems, so far, are generally complex and complicating setups that are expensive and do not provide adequate safety and protection to the UAVs against structural damage as well as against harsh weather elements and conditions.

Prior arts generally cater for docking and launching of UAVs under good weather conditions and, so they are not expected to operate well under wet and gusty conditions or with satisfactory long-term operational reliability needed for remote region applications. The present invention was specifically developed with innovations and features lacking in prior art that will fulfill the requirements for such demanding application including a method for safe and secure stowage of the UAVs and to protect them against unfavorable weather elements and conditions during storage. We believe these unique features introduced by the present invention will help to realize fully autonomous missions involving docking and re-launching of UAVs in harsh and remote regions with unpredictable weather such as in the midst of the Indian Ocean.

### 3. SUMMARY OF THE INVENTION

Accordingly, it is the primary object of the present invention to provide a fully automated docking system for fixed and non-fixed wing unmanned vehicles with the ability to dock, stow in a safe manner, replenish on-board energy storage, and re-launch without human intervention that provides for the handling of fixed wing UAVs capable of “Harrier” manoeuvre and VTOL (vertical take-off and landing manoeuvre).

It is yet another object of the present invention to stow both fixed and non-fixed wing UAVs in an opened top compartment away from weather elements such as gusty winds, rain-water, and damaging ultraviolet exposure,

and to provide electromagnetic mechanism on the docking and launching surface to allow the vehicle to securely attach on the surface during take-off and docking procedures.

It is a further object of the present invention to provide energy harvesting surface to gather solar energy to charge the vehicle energy storage system.

It is yet a further object of the present invention to have a plurality of transceivers on the docking and launching surface to validate signals emitted from the vehicle during a docking procedure, to allow the surface to adjust inclination angle.

It is yet another further object of the present invention to provide for a simple effective and economical operation and manufacturing solution of a docking system for UAVs in VTOL.

Additional objects of the invention will become apparent with an understanding of the following detailed description of the invention or upon employment of the invention in actual practice.

Accordingly the present invention provides for:

A docking system for fixed or non-fixed wing unmanned aerial vehicle comprising:

at least one docking and launching surface to enable said vehicle to dock and launch;

wherein the said docking and landing surface comprising electomagnetic mechanism which energizes during said vehicle when making a docking procedure wherein

at least one energy harvesting surface is disposed opposite of said docking and launching surface to harvest solar energy to charge up said vehicle energy storage system;

and whereby

said launching and docking surface further comprising a plurality of transceivers to validate signals emitted from vehicle transceiver during a docking procedure to enable said vehicle to make self-alignment and dock on said surface.

The present invention provides for

A method of docking system for fixed or non-fixed wing unmanned aerial vehicle for a take-off procedure comprising steps of:

energizing said vehicle propulsion system to suitable pre-determined take-off power; and

releasing latching mechanism on said docking surface to enable said vehicle to be released.

with further procedures of the steps of:

activating transceivers to transmit and emit signals on said vehicle for detecting and ranging the docking system;

turning off said vehicle propulsion; and

rotating said docking surface about the pivot for safe stowage and protected storage of said vehicle.

### 4. BRIEF DESCRIPTION OF THE DRAWINGS

Other aspects of the present invention and their advantages will be discerned after studying the Detailed Description in conjunction with the accompanying drawings in which:

FIG. 1 shows an exemplary side view of apparatus of the present invention with an unmanned aerial vehicle in an initial position of safe stowage and solar energy harvesting.

FIG. 2-A shows a bottom view of an UAV of the present invention.

FIG. 2-B shows an example image as seen by an image processor of the docking system of the present invention. Such information is used to establish the correct final approach.

FIG. 3-A shows a perspective view of three dynamic contact pads which consist of the electromagnetic property and the latching mechanisms of the present invention.

FIG. 3-B shows a closed up view of the contact pad with electromagnetic property and the latching mechanisms of the present invention.

FIG. 3-C shows a closed up view of a landing gear of the vehicle on the contact pad of the present invention.

FIG. 3-D shows a closed up view of the landing gear of the vehicle being latched on by the latching mechanisms of the present invention.

FIG. 3-E shows a closed up view of the latching mechanisms of the present invention which are capable of independently retractable.

FIG. 4-A shows a side view of an array of the apparatus in safe stowage position in the present invention.

FIG. 4-B shows a side view of an array of the apparatus rotated by pivot to allow a plurality of vehicles for take-off/launching procedure of the present invention.

FIG. 4-C shows a side view of a plurality of vehicles take-off from the present invention.

FIG. 4-D shows a side view of a plurality of the apparatus returning to the initial position of safe stowage in the present invention.

FIG. 4-E shows a side view of an unmanned aerial vehicle approaching the docking surface of the present invention which includes the UAV making the “Harrier” manoeuvre in the process in order to achieve an ultimate forward airspeed of less than 15 kmh⁻¹.

FIG. 5-A shows a top view of a plurality of the apparatus being arranged in an array formation in the present invention.

FIG. 5-B shows a top view of a plurality of the apparatus being arranged in a V-formation in the present invention.

FIG. 6-A shows a diagram of take-off procedure of fixed wing UAV of the present invention.

FIG. 6-B shows a diagram of landing or docking procedure of fixed wing UAV of the present invention.

### 5. DETAILED DESCRIPTION OF THE PREFERRED EMBODIMENT

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

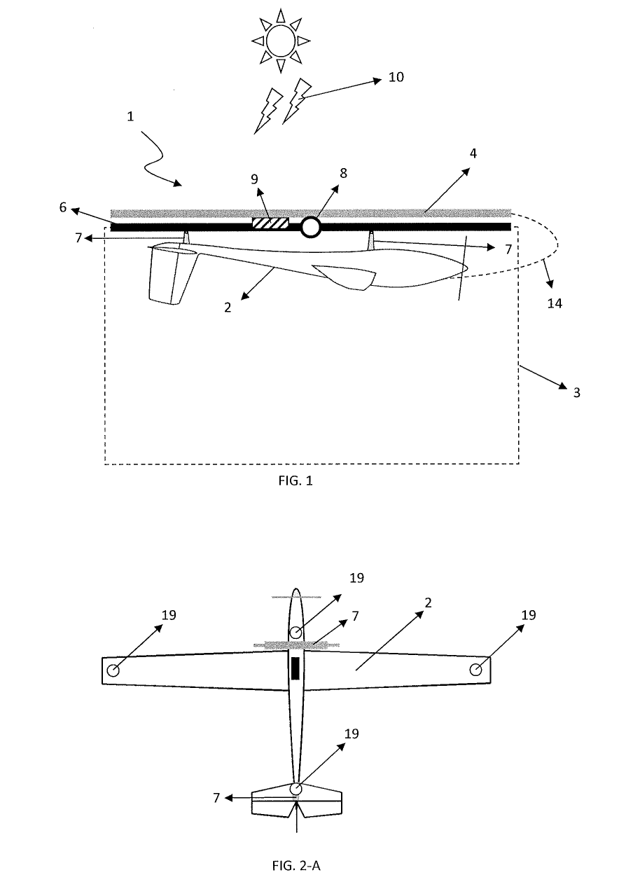

Referring to FIG. 1 illustrates side view of the present invention of docking system (1) for fixed or non-fixed wing unmanned aerial vehicles (2), comprising at least one docking and launching surface (6) to enable a vehicle (2) to dock and launch, and at least one energy harvesting surface (4) is disposed opposite of the surface (6), preferably photovoltaic solar cell, to harvest solar energy (10) to charge up the vehicle (2) energy storage system (not shown) via landing gear (7) or via electric cables (14) to power the vehicle propulsion system. The solar energy (10) can also be used to supply electricity to the mother vehicle (not shown) or to drive an electrolysis reactor (not shown) to generate hydrogen as energy carrier for the vehicle (2). Preferably, the vehicle propulsion system is electrically powered propeller or co-axial propellers. A pivotal means (8) is provided on the docking system to allow the system docking and launching surface (6) to rotate according to which procedures to be executed, such as initial stage of safe stowage of vehicles (2), launching of the vehicles (2), or docking of the vehicles (2). The docking system (1) is preferable to allow the docking and launching surface (6) and the energy harvesting surface (4) mounted in an opened top compartment (3) to protect any vehicles (2) from harmful weather elements such as gusty winds, rain, and ultraviolet rays, with the provision of an integrated single structure comprising of the compartment (3), its cover, docking surface (6) and energy harvesting element in safe stowage and protected storage condition. With the position of the pivot (8) being centrally positioned, aerodynamic stress is minimized in the event of high winds or typhoon related weather conditions.

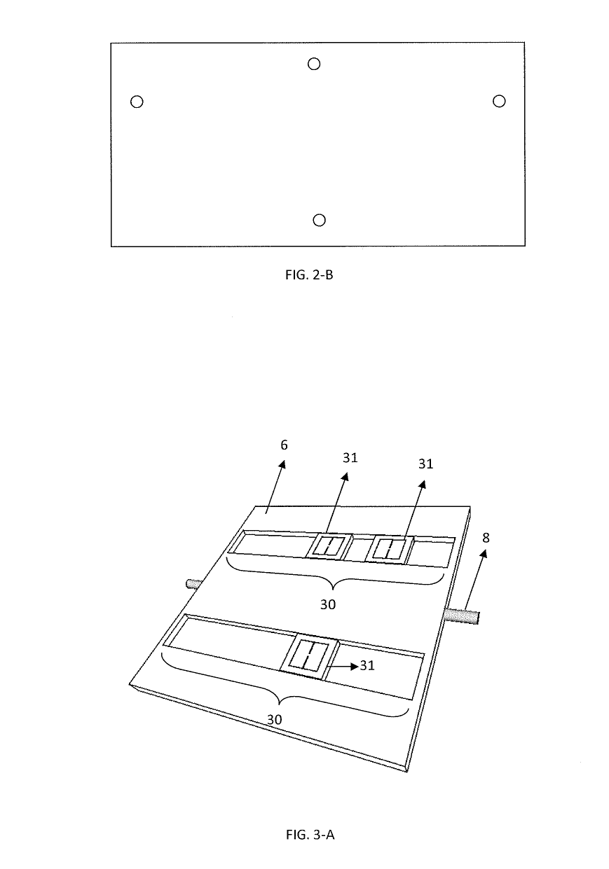

The launching and docking surface (6) further comprising a plurality of transceivers capable of transmitting and/or emitting signals, or a combination thereof, to validate signals emitted from vehicle transceiver (19) which can be mounted on landing gears (7), wing panels, or fuselage as shown in FIG. 2-A. The emitted signals are primarily used for self-alignment purpose for the vehicle (2) during a docking procedure to dock on said surface (6). Similarly, the surface (6) is also capable of self-alignment to allow said vehicle (2) to dock. Conversely, for non-fixed wing vehicle docking, the surface (6) docking and launching will be in an approximately horizontal position preferably.

Signals are defined as visible light or invisible lights such as infrared or the like, audible sound waves, inaudible sound waves such as ultrasound or the like, or radio waves as radio frequency (RF) or the like, or a combination thereof. Depending on the environmental condition, the system (1) and the vehicle (2) can select a signal type best suit for the condition, for example, in foggy weather, transmission and receiving of visible light signal will be affected, thus, L-band waves (1 to 2 GHz) can be used as they are largely unaffected by fog, rain, and cloud.

The vehicle (2) transmits its vehicle information to the docking system (1) at the onset of the final approach, and the docking surface (6) will be set to the correct angle for that particular class of aircraft. Referring to FIG. 2-B, there is shown an example image as seen by an image processor of the docking system (1). Such information is used to establish the correct final approach of said vehicle (2). An on-board computer on the system (1) instructs the locking mechanisms to self-align with the aircraft prior to docking.

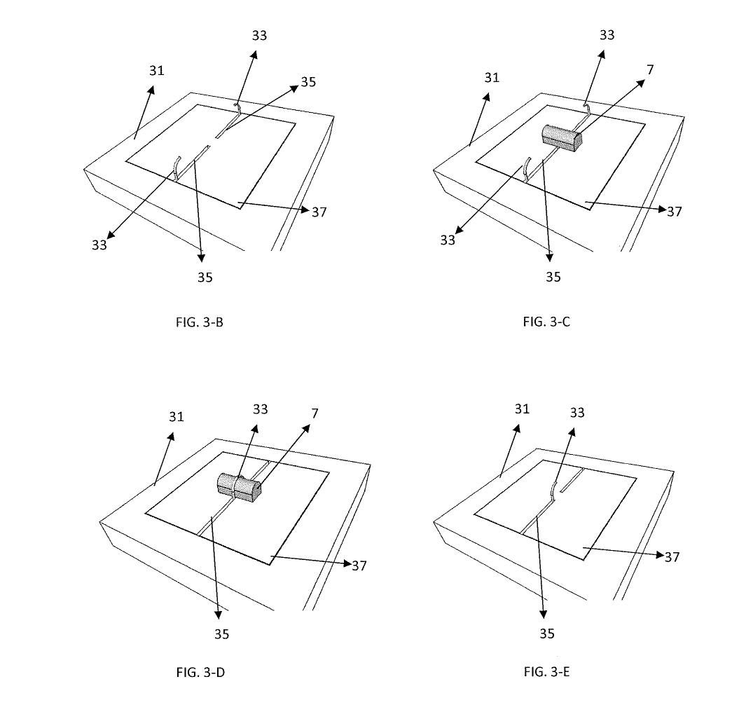

Referring now to FIG. 3-A, there is shown a docking and launching surface (6) comprising a plurality of indentations (30) which couple with at least one contact pad (31) enable said pad (31) to traverse in said indentations (30) when a vehicle (2) is performing a docking procedure. The traverse of the pad (31) is capable of self-alignment and matches the vehicle (2) docking path, in case of the vehicle (2) is veered off-course due to air turbulence.

Referring now to FIG. 3-B, there is shown an initial disengage stage of a single unit of contact pad (31) comprising electromagnet (37), a plurality of indentations (35) which couple with a least one latching mechanism (33). The electromagnet (37) is de-energized with the latching mechanism (33) is disengaged, such as in the scenario of retrieving an approaching unmanned helicopter.

Referring now to FIG. 3-C, there is shown a part of the landing gear (7) of the vehicle (2) is firmly attached on the electromagnet surface (37). The electromagnet (37) is energized with the latching mechanism (33) disengaged, the electromagnet (37) is energized to draw the landing gear (7) onto the electromagnet surface (37) and providing a temporary hold on the gear (7).

Referring now to FIG. 3-D, there is shown the latching mechanism (33) being activated, traversed on the indentations (35), and secured onto the gear (7). the electromagnet surface (37) is de-energized once the latching system (33) has secured the landing gear.

Referring now to FIG. 3-E, the latches (33) can be independently retracted into the contact pad (31) when necessary and this feature is particularly useful during the launching phase of fixed-wing UAVs.

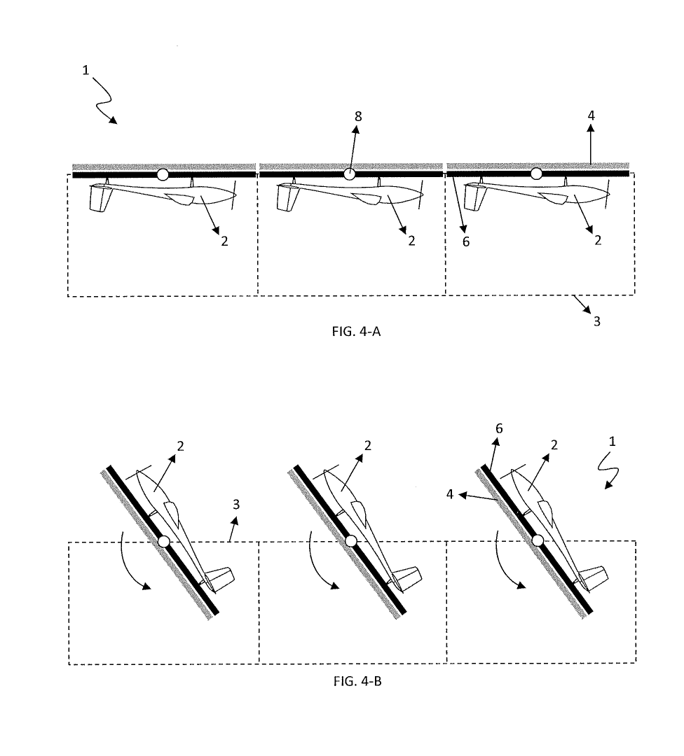

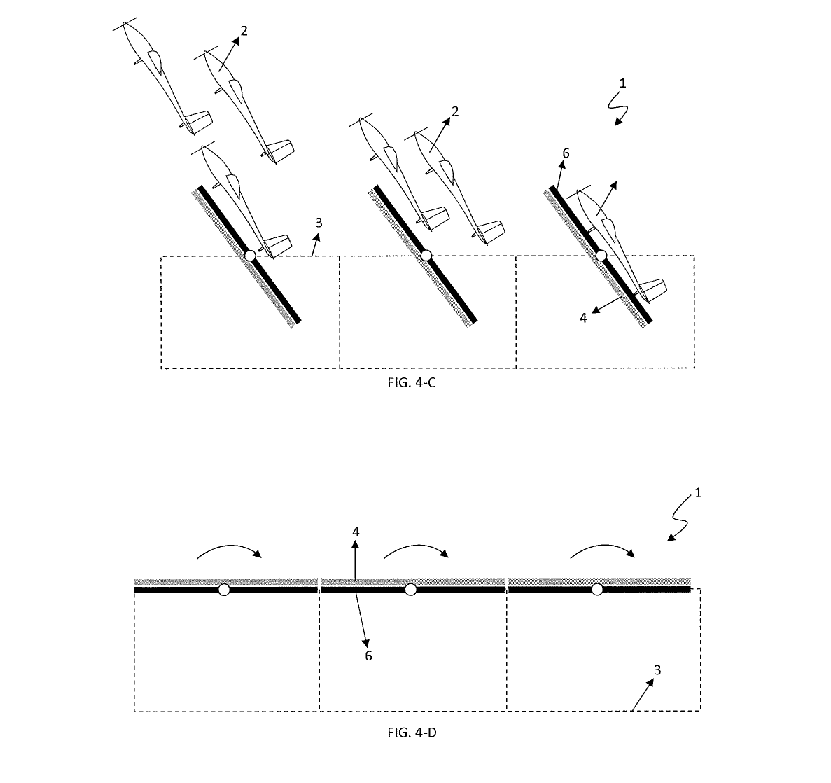

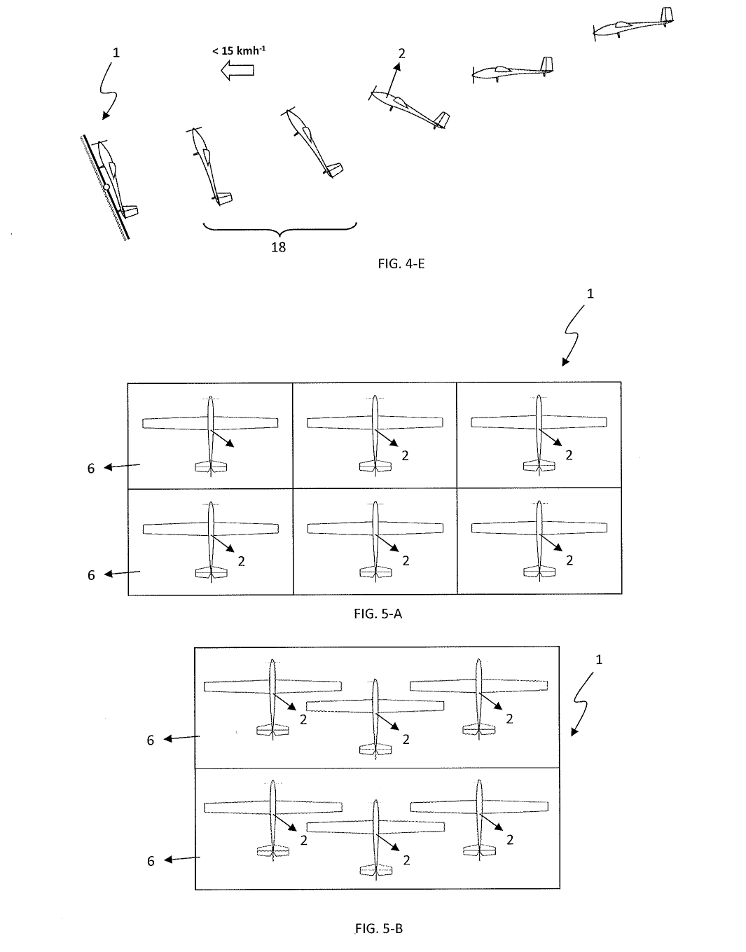

Referring now to FIG. 4-A, there is shown a side view of the present invention with a plurality of vehicles (2) in upside down position, or initial safe stowage position. The vehicles (2) are held onto the docking and launching surface (6) by locking mechanism. In a take-off/launching procedure, referring to FIG. 4-B, the docking and launching surface (6) is rotated to expose the vehicles (2) from the compartment (3). In a take-off procedure, referring to FIG. 4-C, the vehicles (2) propulsion system is engaged and the locking mechanism on the docking and launching surface (6) is set to “release” position to allow the vehicle for take-off. Referring to FIG. 4-D, after the vehicles (2) have departed from the surface (6), the surface (6) can be rotated to the initial safe stowage position. This position also facilitates solar energy harvesting. Referring to FIG. 4-E, during a docking procedure, the vehicle (2) approaches the surface (6), it performs the “Harrier” manoeuvre at a pre-determined distance (18) to achieve slow and controlled forward flight. The docking surface (6) performs auto alignment by tilting the inclination angle, activate the electromagnets and followed by the locking/latch mechanism to secure said vehicle (2) upon docking.

Referring now to FIGS. 5-A and 5-B, there are shown the apparatus of the present invention being arranged in an array formation. However, person skilled in the art would appreciate the other arrangements such as single file, multiple file, or staggered array are possible.

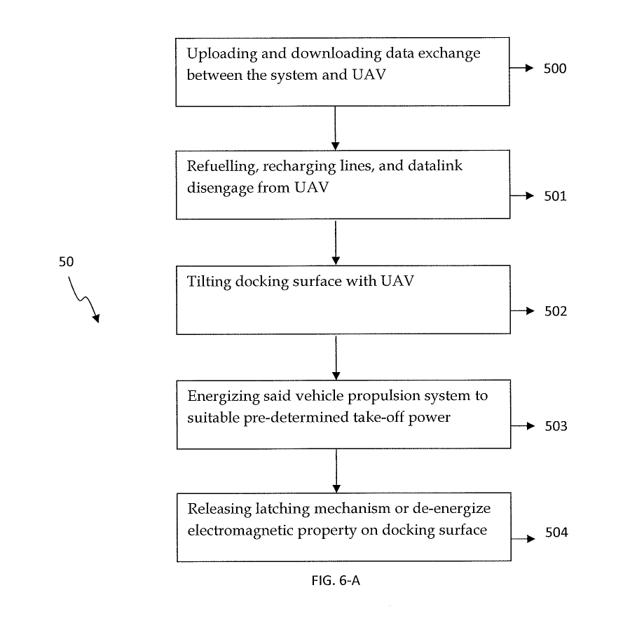

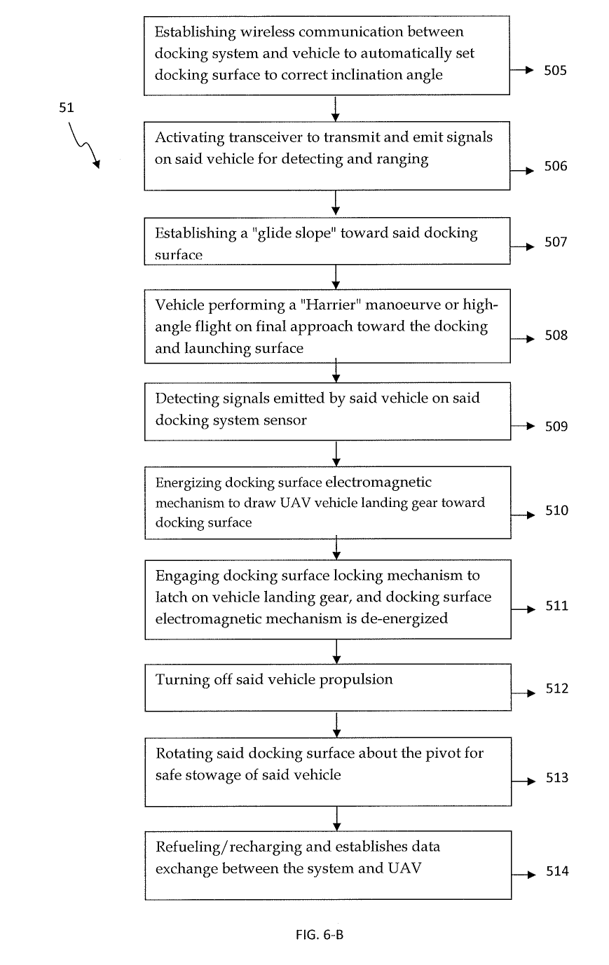

FIG. 6 illustrates the steps taken by the present invention during the cyclical process of docking and re-launching. While the complete process is cyclical in nature, the description herein begins with the take-off procedure and to be followed by the docking procedure.

Referring to FIGS. 6-A and 6-B, there are shown diagrams of the present invention operating during a safe-stowage, launching, and docking procedures of fixed wing unmanned aerial vehicles. Performing a take-off procedure (50), data exchange is carried out between the system and the vehicle in step (500), refuelling, recharging lines, and datalink disengage from said vehicle in step (501), the docking surface is tilted to expose the vehicle (2) to an angle to allow high alpha take-off or vertical take-off in step (502); energizing said vehicle propulsion system to suitable pre-determined take-off power in step (503); releasing latching mechanism or de-energize electromagnetic mechanism on said docking surface (6) to enable said vehicle to be released in step (504).

Performing a docking procedure (51), wireless communication is established between the docking system (1) and the vehicle (2) to automatically set the docking surface (6) to a correct inclination angle in step (505); activating transceivers (19) to transmit and emit signals on said vehicle (2) for detecting and ranging in step (506); initiating final approach toward said docking surface (6) whereby said vehicle (2) is remotely piloted or fully autonomous in step (507); the vehicle (2) performing a “Harrier” manoeuvre or high-angle flight on final approach toward the docking and launching surface (6) in step (508), detecting signals emitted by said vehicle (2) on said docking system transceivers (9) and continuously fine tuning the lateral position of locking/latching mechanisms until said vehicle (2) completes the docking procedure in step (509); energizing docking surface electromagnetic mechanism to draw said vehicle landing gear (7) toward said docking surface (6) to prevent said vehicle (2) from rebound landing in step (510); engaging docking surface locking mechanism (33) to latch on said vehicle landing gear (7), and said docking surface (6) electromagnetic mechanism is de-energized in step (511); turning off said vehicle propulsion in step (512); rotating said docking surface (6) about the pivot (8) for safe stowage of said vehicle in step (513); and refuelling/recharging and establishes data exchange between the system and the vehicle in step (514).

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

1. A docking system (1) for fixed or non-fixed wing unmanned aerial vehicle (2), comprising:
at least one docking and launching surface (6) to enable said vehicle (2) to dock and launch;
characterized in that
said docketing and launching surface (6) comprises electromagnetic-mechanism (32) which energizes when said vehicle (2) is making a docking procedure,
with at least one energy harvesting surface (4) is disposed opposite of said docking and launching surface (6) to harvest solar energy to charge up said vehicle (2);
wherein said energy harvesting surface (4) is mounted in an open top compartment (3) to protect any vehicle (2) from harmful weather elements such as gusty winds, rain and ultraviolet rays;
further characterized in that
said docking and launching surface (6) and said energy harvesting surface (4) are rotatable by a pivotal means (8) provided on the docking system (1) to allow the docking and launching surface (6) to rotate according to which procedures to be executed, such as initial stage of safe stowage of vehicles (2), launching of the vehicles (2), or docking of the vehicles (2).

2-4. (canceled)

5. The docking system (1) for fixed or non-fixed wing unmanned aerial vehicle (2) as claimed in claim 1 wherein said docking and launching surface (6) comprising at least one contact pad (31) traverses in a plurality of tracks (30)
wherein said pads (31) are capable of self-alignment with the vehicle (2) to allow said vehicle (2) to dock;
and wherein, said pads (31) further comprising a plurality of latching mechanisms (33) which traverse in a plurality of indentations (35) to latch on vehicle landing gear (7);
and wherein said latching mechanisms (33) are capable of latching and retracting independently.

6-8. (canceled)

9. The docking system (1) for fixed or non-fixed wing unmanned aerial vehicle (2) as claimed in claim 1 said vehicle (2) comprising a plurality of transceivers (19), preferably on the landing gear and wing bottom portion to establish wireless communication with said transceivers (9) on the docking and launching surface (6) during a docking procedure to enable said vehicle (2) to make self alignment and dock on said surface (6).

10. The docking system (1) for fixed or non-fixed wing unmanned aerial vehicle (2) as claimed in claim 1 wherein said energy harvesting surface (4) is capable of generating electricity for electricity consuming applications in said system (1) and to produce hydrogen fuel via electrolysis for said vehicle (2).

11. The docking system (1) for fixed or non-fixed wing unmanned aerial vehicle (2) as claimed in claim 1 wherein said vehicle (2) is capable of “Harrier” manoeuvre or high angle of attack (“high alpha”), slow controlled forward flight, and vertical take-off and landing.

12. (canceled)

13. The docking system (1) for fixed or non-fixed wing unmanned aerial vehicle (2) as claimed in claim 1 wherein said signals are visible or invisible light, audible or inaudible sound waves, or radio waves, or a combination thereof.

14-25. (canceled)

26. A method of docking system (1) for fixed or non-fixed wing unmanned aerial vehicles (2), comprising:
at least one docking and launching surface (6) to enable said vehicle (2) to dock and launch;
wherein said docking and launching surface (6) comprises electromagnetic mechanism (37) which energises when said vehicle (2) is making a docking procedure with at least one energy harvesting surface (4) is disposed opposite of said docking and launching surface (6) to harvest solar energy to charge up energy storage system of the said vehicle (2);
and wherein said energy harvesting surface (4) is mounted in an opened top compartment (3) to protect any vehicle (2) from harmful weather elements such as gusty winds, rain and ultraviolet rays;
and whereby said docking and launching surface (6) and said energy harvesting surface (4) are rotatable by a pivotal means (8) provided on the docking system (1) to allow the docking and launching surface (6) to rotate according to which procedures to be executed, such as initial stage of safe stowage of vehicles (2), launching of the vehicles (2), or docking of the vehicles (2) according to which procedures to be executed, such as initial stage of safe stowage of vehicles (2), launching of the vehicles (2) or docking of the vehicles (2) comprising the steps of:
data exchange carried out between the system and the vehicle (500);
refuelling, recharging lines, and datalink disengage from said vehicle (501);
the docking surface is tilted to expose the vehicle (2) to an angle to allow high alpha take-off or vertical take-off (502);
energizing said vehicle propulsion system to suitable pre-determined take-off power (503);
releasing latching mechanism or de-energize electromagnetic mechanism on said docking surface (6) to enable said vehicle to be released (504);
when performing a take-off procedure (50);
and wherein wireless communication is established between the docking system (1) and the vehicle (2) to automatically set the docking surface (6) to a correct inclination angle (505);
activating transceivers (19) to transmit and emit signals on said vehicle (2) for detecting and ranging (506);
initiating final approach toward said docking surface (6) whereby said vehicle (2) is remotely piloted or fully autonomous (507);
the vehicle (2) performing a “Harrier” manoeuvre or high-angle flight on final approach toward the docking and launching surface (6) (508);
detecting signals emitted by said vehicle (2) on said docking system transceivers (9) and continuously fine tuning the lateral position of locking/latching mechanisms until said vehicle (2) completes the docking procedure (509);
energizing docking surface electromagnetic mechanism to draw said vehicle landing gear (7) toward said docking surface (6) to prevent said vehicle (2) from rebound landing (510);
engaging docking surface locking mechanism (33) to latch on said vehicle landing gear (7), and said docking surface (6) electromagnetic mechanism is de-energized (511);
turning off said vehicle propulsion (512);
rotating said docking surface (6) about the pivot (8) for safe stowage of said vehicle (513);
and refuelling/recharging and establishes data exchange between the system and the vehicle (514);
when performing a docking procedure (51).
